(19) United States
(12) Patent Application Publication
(10) Pub. No.: US 2025/0205643 A1
(43) Pub. Date: Jun. 26, 2025

(54) METHOD FOR EXHAUST GAS AFTER-TREATMENT OF AN INTERNAL COMBUSTION ENGINE HAVING AT LEAST ONE SCR CATALYST

(71) Applicant: Robert Bosch GmbH, Stuttgart (DE)

(72) Inventors: Stefanos Tzivanakis, Waiblingen (DE); Arman Khosravani, Freiberg Am Neckar (DE); Thorsten Meier, Pfinztal-Kleinsteinbach (DE)

(21) Appl. No.: 18/989,161

(22) Filed: Dec. 20, 2024

(30) Foreign Application Priority Data
Dec. 22, 2023 (DE) 10 2023 213 242.7

(51) Int. Cl. B01D 53/94

(52) U.S. Cl. CPC B01D 53/9418; B01D 53/9495; B01D 2257/406; B01D 2258/012

(57) ABSTRACT

A method for exhaust gas after-treatment of an internal combustion engine (10) having at least one SCR catalyst (22),
wherein the at least one SCR catalyst (22) is subdivided into at least two virtual bricks,
wherein, by means of a first control, a control of the at least one SCR catalyst (22) according to an overall NH3 target fill level (NH3_{ges}) is carried out, wherein a switching from the first control into a second control for the at least one SCR catalyst (22) is carried out, wherein the second control of a NH3 fill level control is carried out based on a target NH3 fill level (mNH3Cat_{Soll,SCR1B}) of the first virtual brick of the at least one SCR catalyst (22).

### BACKGROUND

Selective catalytic reduction (SCR) using ammonia (NH3) or ammonia-releasing reagents is a promising method for mitigating nitrogen oxides in oxygen-rich exhaust gases. The working window of a SCR catalyst or its efficiency is defined by the physical variables of temperature and space velocity. The degree of coverage of the catalyst with adsorbed NH3 determines its efficiency. As the temperature increases, the ability of the SCR catalyst to store ammonia decreases. In order to maintain high levels of efficiency, the amount of ammonia to be converted must be dosed instantaneously to the measured amount of nitrogen oxide upstream of the SCR catalyst. Ammonia that does not react with NOx, that is desorbed as ammonia slip from the catalyst or that is oxidized by the high temperature on the catalyst, must also be dosed. In order to achieve the highest nitrogen oxide conversion rate possible, the SCR system must operate at a high ammonia fill level. As the temperature of the filled SCR catalyst increases due to a load jump of the internal combustion engine, its ammonia storage capacity of the SCR catalyst decreases, which may result in ammonia slip. SCR catalysts that are installed close to the engine in order to convert nitrogen oxides early after the engine starts are particularly subject to dynamic temperature gradients. This fact can lead to increased NH3 desorption depending on NH3 fill level load and/or its gradients. A second SCR catalyst downstream of the first SCR catalyst can therefore be provided in the exhaust system to adsorb and subsequently convert ammonia from ammonia slip of the first catalyst. The Onboard Diagnostic (OBD) guidelines require that both SCR catalysts be monitored.

### SUMMARY

In a first aspect, the invention relates to a method for exhaust gas after-treatment of an internal combustion engine having at least one SCR catalyst, wherein the at least one SCR catalyst is subdivided into at least two virtual bricks, wherein, by means of a first control, a control of the at least one SCR catalyst according to an overall NH3 target fill level is carried out, characterized in that a switching from the first control into a second control for the at least one SCR catalyst is carried out, wherein the second control of a NH3 fill level control is carried out based on a target NH3 fill level of the first virtual brick of the at least one SCR catalyst.

The method has the particular advantage that, by controlling based on the target NH3 fill level of the first virtual brick of the SCR catalyst, improved NOx emissions can be obtained.

Due to the control on the first virtual brick of the SCR catalyst, ammonia is applied to the front region in a targeted manner, and a significantly improved NOx turnover is obtained.

In particular at low temperatures and rapid load changes of the internal combustion engine, a high efficiency can thus be ensured and an improved emissions cleaning can thus be carried out.

In one particular embodiment, when a transient operating state for the internal combustion engine is detected and a determined variable threshold value is undershot, there is a switch from the first control into the second control.

In particular in the transient operating states, the control type on the first virtual brick is particularly efficient, because improved utilization of the freely accessible surface of the SCR catalyst in contact with the gas phase is obtained. Diffusive transport into deeper layers of the catalytic material (washcoat) is largely dependent on the concentration gradient. This means that the speed of the gas exchange decreases in the radial direction.

In a further configuration, a transient operating state is present when a transition from a stationary or quasi-stationary operating state into a non-stationary operating state is detected for the internal combustion engine.

In a particular embodiment, the transient operating state is determined as a function of a change in an enthalpy in the exhaust gas tract, in particular arising from a temperature difference between a SCR catalyst temperature and a temperature upstream of the at least one SCR catalyst.

By means of the monitored change of the enthalpy in the exhaust gas tract, strong load point changes can be detected quickly and robustly.

For example, the change in enthalpy can be carried out as a function of a temperature difference between the temperature of the SCR catalyst and a temperature upstream of the SCR catalyst.

By monitoring the change in enthalpy, it can be detected whether a critical NH3 degradation state is given for the SCR catalyst.

Thus, it can be evaluated whether a sufficient fill level amount is maintained for the fill level distribution of the SCR catalyst, in particular for the first virtual brick, in order to ensure a sufficiently high NOx turnover.

In a particular configuration, upstream of the at least one SCR catalyst, a diesel oxidation catalyst is arranged.

The method has the particular advantage that the diesel oxidation catalyst produces an attenuation of the temperature in the exhaust gas tract.

In an advantageous configuration, the change in enthalpy is determined as a function of a SCR catalyst temperature of the at least one SCR catalyst and a first temperature of the diesel oxidation catalyst.

The method has the particular advantage that the first temperature is attenuated by the preceding diesel oxidation catalyst, and in particular this resembles a PT1 filtering and thus there is no sudden temperature change in the temperature signal of the SCR catalyst.

The method according to the disclosure characterized in that a difference between a target NH3 fill level of the first brick and an actual NH3 fill level for the first brick is determined.

The method has the particular advantage that an increase in the turnover rate can be obtained, and thus a more effective utilization of the catalyst surface and thus of the SCR catalyst is obtained.

In an alternative configuration, a variable threshold value is determined as a function of the determined enthalpy and/or a current load of the internal combustion engine and/or a rotational speed and/or an ammonia slip risk.

The method has a particular advantage, because a reduction of the risk of high NH3 slip or a minimization of the NH3 slip can thus be achieved.

In a particular embodiment, if the difference falls below the variable threshold, in particular for a specifiable time, the control of the SCR system is carried out based on the second control.

In an advantageous embodiment, if the difference exceeds the variable threshold, in particular for a specifiable period of time, the control of the SCR system is carried out based on the first control.

In a particular configuration, the ammonia slip risk is determined as a function of the target NH3 fill level and the actual NH3 fill level of the nth virtual brick of the at least one SCR catalyst.

The method has a particular advantage, because a reduction of the risk of high NH3 slip or a minimization of the NH3 slip can thus be achieved.

In further aspects, the invention relates to an apparatus, in particular a control apparatus and a computer program, configured and in particular programmed so as to carry out any one of the methods. In yet another aspect, the invention relates to a machine-readable storage medium on which the computer program is stored.

### BRIEF DESCRIPTION OF THE DRAWINGS

The invention will be explained in more detail in the following with reference to an exemplary embodiment shown in the figures. Shown are:

FIG. 1 a schematic illustration of an internal combustion engine having an exhaust gas after-treatment system according to the invention; and

FIG. 2 a flow chart for graphically representing the sequence of an exemplary embodiment of the method.

### DETAILED DESCRIPTION

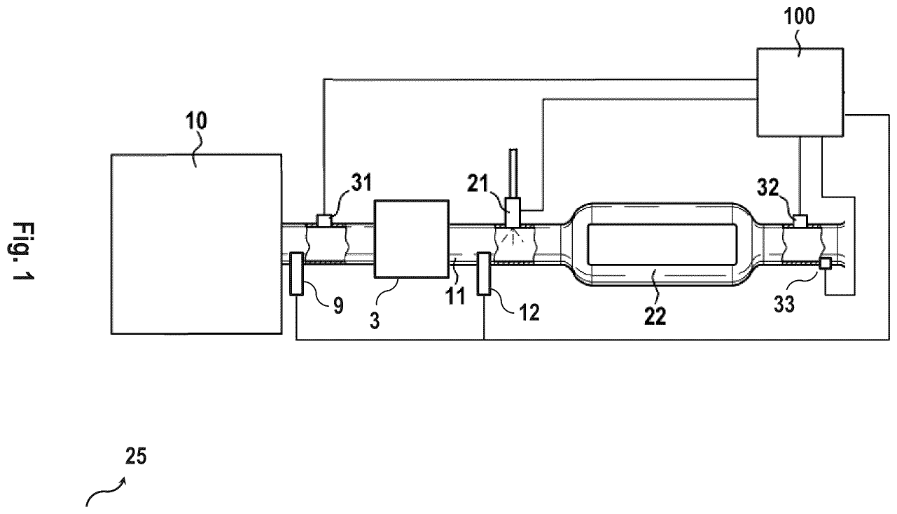

An internal combustion engine 10 comprises in its exhaust gas tract 11 a SCR exhaust gas after-treatment system 25 having at least one SCR catalyst 22, which is shown in FIG. 1. The latter comprises a reductant dosing unit 21 with which a urea solution (AdBlue) can be injected into the exhaust gas tract 11. Ammonia is released from this in case of high temperatures of the exhaust gas. Downstream of the internal combustion engine 10, there are located a first temperature sensor 9 and a first NOx sensor 31. In a particular configuration, downstream of the internal combustion engine 10 and upstream of a first SCR catalyst 22, there is a diesel oxidation catalyst 3. Downstream of the diesel oxidation catalyst 3 is arranged a reductant dosing unit 21, a second temperature sensor 12, and the first SCR catalyst 22. Further SCR catalysts can be arranged downstream of the first SCR catalyst 22. The first NOx sensor 31 measures a first NOx concentration sensor value NOx1, preferably as a NOx concentration or as a NOx mass flow. A second NOx sensor 32 is arranged downstream of the first SCR catalyst 22 and measures a second NOx concentration sensor value NOx2, preferably as a NOx concentration or as a NOx mass flow. The same is true in particular for the NH3 concentration or a NH3 mass flow.

In an optional configuration, a NH3 sensor 33 can further be installed downstream of SCR catalyst 22. The NH3 sensor can determine a NH3 mass flow.

All NOx sensors 31, 32 relay their signals to an electronic control unit 100. Because the NOx sensors 31, 32 are also cross-sensitive to ammonia in addition to nitrogen oxides, their signals represent sum signals of nitrogen oxides and ammonia. However, the first NOx sensor 31 is arranged upstream of the reductant dosing unit 21 so that it reliably only measures the nitrogen oxide amount in the exhaust gas. The reductant dosing unit 21 also reports to the control unit 100 the amount of ammonia dosed into the exhaust gas tract 11.

The temperature and NOx sensors mentioned above are connected to a control unit 100 and their signals are received and stored by the control unit 100.

In particular, a first temperature, T_{lst,Kat1}, in particular for the diesel oxidation catalyst 3, and a SCR catalyst temperature T_{SCR} of the SCR catalyst 22 can be determined using a temperature model stored on the control unit 100 as a function of the first temperature sensor.

Furthermore, the system shown includes a known SCR injection system consisting of a SCR tank having a pumping unit, which supplies urea fluid and/or reductant at a specifiable pressure to the urea injection valve 21 in the known manner. The SCR injection system is controlled using a control strategy stored on the control unit 100. By means of the injection valve 21, urea-containing after-treatment fluid is dosed into the exhaust gas flow.

Furthermore, metrics such as exhaust gas mass flow, ambient temperature, Tₑₙᵥ and rotational speed n_{eng} 10 can be retrieved in the control unit 100 in the known manner.

To determine a NH3 fill level, a NH3 fill level model for SCR catalysts 4 is stored in the control unit 100.

The modeled first NH3 fill level NH3_{mod,Kat1} for the SCR catalyst 22 is determined by means of a first NH3 fill level model, in particular by means of a reaction-kinetic model or an Arrhenius model, as a function of the amount of urea dosed through the first dosing valve 21 and/or the concentration of NOx measured with the first NOx sensor before the first SCR catalyst 22 and/or the SCR catalyst temperature T_{SCR} of the first SCR catalyst 22 and/or the exhaust gas mass flow rate \dot{m}ₑₓₕ and/or the ambient temperature Tₑₙᵥ.

A stationary or quasi-stationary state is present when, for example, a change in rotational speed and/or a change in air mass flow and/or an engine torque change and/or an accelerator pedal position change does not substantially change at a predetermined time interval.

A detection of the non-stationary or dynamic operating state of the internal combustion engine is preferably substantially changed or greatly changed via a change in rotational speed and/or a change in air mass flow and/or an engine torque change and/or an accelerator pedal position change at a predetermined time interval. The detection is carried out by means of the control unit 100, which continuously receives and subsequently evaluates a rotational speed n_{eng} and/or an accelerator pedal position w_{pedal} and/or a mass air flow \dot{m}ₐᵢᵣ and/or a torque M.

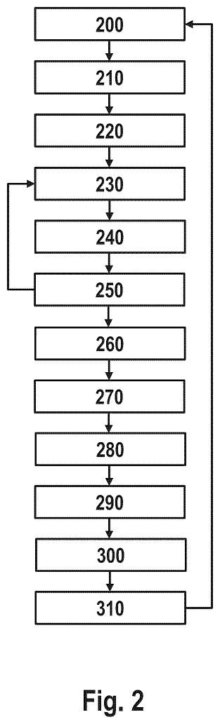

FIG. 2 illustrates by way of example the sequence of the method for an exhaust gas after-treatment system having only one SCR catalyst 22 described, wherein the SCR catalyst 22 is virtually subdivided into n-bricks.

In the following, the method for an exhaust gas after-treatment system having only one SCR catalyst 22 is described, wherein the SCR catalyst 22 is subdivided into at least two virtual bricks.

In a step 200 dm_{EG}, an exhaust gas mass flow, an exhaust pressure p, a SCR catalyst temperature T_{SCR}, an oxygen concentration O₂, a NOx concentration NOx_{Us} downstream of the internal combustion engine 10, and upstream of the SCR catalyst 22, and a desired NOx conversion efficiency n_{NOx} are continuously determined by the controller 100.

In particular, as a function of the determined exhaust gas temperature Tₑₓₕ, a brick temperature T_{SCR,i} is determined for each brick of the SCR catalyst 22 by means of a temperature model stored on the control unit 100.

The desired NOx conversion efficiency η_{NOx} can be determined or specified from a grid as a function of the SCR catalyst temperature T_{SCR} and/or exhaust gas mass flow dm_{EG}. The grid is determined in an application phase and stored in the control unit 100.

In an alternative configuration, two SCR catalysts (different cannings) are positioned in a row. In this configuration, the desired target NOx conversion efficiency can η_{NOx} also be determined as a function of the state of the second catalyst. Here, the variables of actual NOx conversion efficiency η_{NOx,lst} and/or actual NH3 individual fill levels m_{NH3,lst,i} and/or the actual NH3 fill level can be m_{NOx,ges} used.

The method then continues in a step 210.

In a first step 210, a release condition for the method is reviewed. To this end, a dosing readiness for the SCR injection system 25 is determined by the control unit 100. This is carried out primarily via the feedback of the pressure reported back by the pumping unit p. If the pressure p of the SCR injection system determined by the control unit 100 exceeds a specifiable pressure threshold, the SCR injection system is thus dosing-ready.

Additionally, the SCR catalyst temperature T_{SCR} of the SCR catalyst 22 can be determined by the control unit 100. If the SCR catalyst temperature exceeds T_{SCR} a specifiable temperature T_{Kat,min}, in particular 180° C., then the operating temperature for the SCR catalyst 22 is achieved and the release condition is granted.

The method then continues in a step 220.

In a step 220, a SCR model F is used in order to determine the current actual NH3 fill level distribution NH3ₗₛₜ for the SCR catalyst 22. The input variables for SCR model F are continuously determined from the step 200.

In a particular configuration, the target NH3 fill level distribution and the target NH3 total fill level can be F⁻¹ calculated via an inverse model. An estimated start value is determined for a numerical solution of the inverse model.

In a first embodiment, the start value can be determined using a solution of the inverse model F⁻¹ at a previous point in time t−1, wherein this approach is based on the fact that no abrupt changes in NOx and NH3 concentrations occur within intervals smaller than 100 ms.

In a second embodiment, the start value is NH3ₗₛₜ determined using a current actual NH3 fill level distribution for the SCR catalyst 22.

In a third embodiment, the start value can be determined from a calculation for a SCR catalyst 22 having only one brick. For this purpose, the inverse model F⁻¹ is analytically solved for the one-brick case, and an overall NH3 target fill level NH3_{ges} is obtained for the SCR catalyst 22. This overall NH3 target fill level NH3_{ges} is then distributed across the SCR catalyst 22.

Thus, a start value for the method can be determined, and the method can be continued in a step 230.

In a step 230, the NOx concentrations and the NH3 concentrations are iteratively dissolved according to the formulas (3) and (4):

$${x}_{NOx , i}^{ds} = {r}_{NOx} ( {m}_{NH 3 , i} , {T}_{SCR , i} , {dm}_{EG} , {x}_{NH 3 , i - 1}^{ds} , {x}_{NOx , i - 1}^{ds} , {x}_{O 2} , p ) \qquad ( 3 )$$

$${x}_{NH 3 , i}^{ds} = {r}_{NH 3} ( {m}_{NH 3 , i} , {T}_{SCR , i} , {dm}_{EG} , {x}_{NH 3 , i - 1}^{ds} , {x}_{NOx , i - 1}^{ds} , {x}_{O 2} , p ) \qquad ( 4 )$$

where x_{k,0}^{ds}=xₖ^{us}, r_{NOx} is the function for calculating NOx concentrations, r_{NH3} is the function for calculating NH3 concentrations, m_{NH3,i} is the i-th NH3 mass, T_{SCR,i} is the temperature of the i-th brick, x_{NH3,i-1}^{ds} is the NH3 concentration of the previous brick, x_{NOX,i-1}^{ds} is the NOx concentration of the previous brick, x_{O2} is the oxygen concentration, and p is the exhaust pressure.

The method then continues in a step 240.

In a step 240, a balancing of the NOx and NH3 concentrations upstream and downstream of each brick i is determined according to the formula (7):

$$\frac{\partial {m}_{NH 3 , i}}{\partial t} = - ζ {x}_{NOx , i - 1}^{ds} {η}_{NOx , i} + {x}_{NH 3 , i - 1}^{ds} - {x}_{NH 3 , i}^{ds} + φ \qquad ( 7 )$$

where η_{NOx,i} is the NOx conversion efficiency of the i-th brick, x_{NOX,i-1}^{ds} is the NOx concentration of the previous brick, x_{NH3,i-1}^{ds} is the NH3 concentration of the previous brick, and ξ is a stoichiometric factor corresponding to the NH3 equivalents from the NOx conversion, in particular in the range of [1:1,3̅].

In a step 250, it is checked whether the equation (11) is satisfied for all of the bricks i of the SCR catalyst 22:

$$( - ξ {x}_{NOx , i - 1}^{ds} {η}_{NOx , i} + {x}_{NH 3 , i - 1}^{ds} - {x}_{NH 3}^{ds} ) \leq {∈}_{tol} . \qquad ( 11 )$$

wherein ϵₜₒₗ is a suitable, specifiable tolerance threshold. This tolerance threshold can preferably be interpreted as a rate of change of the target NH3 individual fill levels NH3_{Soll}, i.e. it indicates how much the fill levels are allowed to change in the defined stationary point. This may be determined in an application phase for the SCR catalyst 22.

If the tolerance threshold is not met for all of the bricks i, the method is continued again in step 230, wherein an adaptation of the NH3 fill levels for the current estimate (at the start of the method, this is the start value) is carried out. This may be done, for example, by a Newton-based method. To do so, the derivative matrix (Jacobi matrix) of the function to be minimized for formula (11) must be calculated:

$$J = [ \frac{\partial }{\partial {m}_{NH 3 , j}} ( \frac{\partial {m}_{NH 3 , i}}{\partial t} ) ] , i , j = 1 , … , {n}_{b} und J ∈ {ℝ}^{{n}_{b} {xn}_{b}} \qquad ( 12 )$$

The quotient of the function to be minimized and the Jacobi matrix determines the step size and direction of the adaptation of the current estimate according to the formula:

$${m}_{NH 3 , i}^{[ l ]} = {m}_{NH 3 ,}^{[ l - 1 ]} - {J}^{- 1} ( \frac{\partial {m}_{NH 3 , i}}{\partial t} ) \qquad ( 13 )$$

In the event that the condition from formula (11) is satisfied for all of the bricks i, the method is continued in a step 260.

In a step 260, the target NH3 individual fill levels are then combined to an overall NH3 target fill level NH3_{ges} and the method can be continued in a step 270.

In a step 270, a change to an enthalpy E in the exhaust gas system is determined.

In a preferred embodiment, the change in enthalpy E is determined as a function of the SCR catalyst temperature T_{SCR} of the first SCR catalyst 22 and a first temperature T_{lst,Kat1} of the diesel oxidation catalyst 3.

In an alternative configuration, an alternative catalyst can also be installed in the system in place of the diesel oxidation catalyst 3, and the temperature of the alternative catalyst can be used in order to determine the enthalpy E.

In a preferred configuration, an exponential smoothing is formed for the enthalpy E.

In an alternative configuration, the enthalpy E is determined as a function of a comparison between a temperature upstream of the diesel oxidation catalyst 3 and a temperature upstream of the SCR catalyst 22.

The method then continues in a step 280.

In a step 280, a difference D between the target NH3 fill level mNH3Cat_{Soll,SCR1B} for the first brick and the actual NH3 fill level mNH3Cat_{lst,SCR1B} for the first brick is determined.

The method then continues in a step 290.

In a step 290, a variable threshold value Sᵥₐᵣ is determined as a function of the determined enthalpy E, a current load of the internal combustion engine 10, the rotational speed n_{eng}, and an ammonia slip risk.

The ammonia slip risk can be determined as a function of the target NH3 fill level mNH3Cat_{Soll,SCRnB} and the actual NH3 fill level mNH3Cat_{lst,SCRnB} of the nth brick of the SCR catalyst 22.

The method then continues in a step 300.

In a step 300, the difference D determined in step 280 is checked against the variable threshold value Sᵥₐᵣ determined in step 290.

If the difference D falls below the variable threshold value Sᵥₐᵣ, the control strategy for the SCR system 25 is carried out based on the first virtual brick.

In a preferred configuration, a time can be specified at which the difference D must exceed the variable threshold Sᵥₐᵣ until the control strategy for the SCR system 25 is carried out based on the first virtual brick.

If the difference D exceeds the variable threshold value Sᵥₐᵣ, in particular for a specifiable time, a control strategy for the at least one SCR catalyst 22 is carried out based on the overall NH3 target level NH3_{ges}.

The method then continues in a step 310.

In a step 310, the determined desired target NH3 fill level is added to the dosing strategy and adjusted by means of a dosing strategy, preferably by means of a P-control between the target and actual value. In particular, the determined dosing amount can be subdivided into a defined time constant. The proportion of the P-control is added to the pilot amount.

The method can then be started from the beginning in step 200 or terminated.

1. A method for exhaust gas after-treatment of an internal combustion engine (10) having at least one SCR catalyst (22),
wherein the at least one SCR catalyst (22) is subdivided into at least two virtual bricks,
wherein, by means of a first control, a control of the at least one SCR catalyst (22) according to an overall NH3 target fill level (NH3_{ges}) is carried out, wherein a switching from the first control into a second control for the at least one SCR catalyst (22) is carried out, wherein the second control of a NH3 fill level control is carried out based on a target NH3 fill level (mNH3Cat_{Soll,SCR1B}) of the first virtual brick of the at least one SCR catalyst (22).

2. The method according to claim 1, wherein a switch is made from the first control into the second control when a transient operating state for the internal combustion engine (10) is detected and a determined variable threshold value (S_{□□□}) is undershot.

3. The method according to claim 2, wherein a transient operating state is present when a transition from a stationary or quasi-stationary operating state into a non-stationary operating state is detected for the internal combustion engine (10).

4. The method according to claim 2, wherein the transient operating state is determined as a function of a change in an enthalpy (E) in the exhaust gas tract, arising from a temperature difference between a SCR catalyst temperature (T_{□□□}) and a temperature upstream of the at least one SCR catalyst (22).

5. The method according to claim 1, wherein a diesel oxidation catalyst (3) is arranged upstream of the at least one SCR catalyst (22).

6. The method according to claim 4, wherein the change in enthalpy (E) is determined as a function of a SCR catalyst temperature (T_{□□□}) of the at least one SCR catalyst (22) and a first temperature (T_{lst,Kat1}) of the diesel oxidation catalyst (3).

7. The method according to claim 1, wherein a difference (D) between a target NH3 fill level (mNH3Cat_{Soll,SCR1B}) of the first brick and an actual NH3 fill level (mNH3Cat_{lst,SCR1B}) for the first brick is determined.

8. The method according to claim 1, wherein a variable threshold value(S) is determined as a function of the determined enthalpy (E) and/or a current load of the internal combustion engine (10) and/or a rotational speed (n_{□□□}) and/or an ammonia slip risk.

9. The method according to claim 1, wherein, when the difference (D) falls below the variable threshold value (S_{□□□}), the control of the SCR system (25) is carried out based on the second control.

10. The method according to claim 1, wherein, when the difference (D) exceeds the variable threshold (S_{□□□}), the control of the SCR system (25) is carried out based on the first control.

11. The method according to claim 8, wherein the ammonia slip risk is determined as a function of the target NH3 fill level (mNH3Cat_{Soll,SCRnB}) and the actual NH3 fill level (mNH3Cat_{lst,SCRnB}) of the nth virtual brick of the at least one SCR catalyst (22).

12. A non-transitory, computer readable storage medium containing instructions that when executed by a computer cause the computer to control an exhaust gas after-treatment of an internal combustion engine (10) having at least one SCR catalyst (22), by
subdividing the at least one SCR catalyst (22) into at least two virtual bricks,
controlling, by means of a first control, the at least one SCR catalyst (22) according to an overall NH3 target fill level (NH3_{□□□}), wherein a switching from the first control into a second control for the at least one SCR catalyst (22) is performed, wherein the second control of a NH3 fill level control is performed based on a target NH3 fill level (mNH3Cat_{Soll,SCR1B}) of the first virtual brick of the at least one SCR catalyst (22).

13. A control unit (100), which is configured to carry out a method according to claim 1.
